(19) United States
(12) Patent Application Publication
(10) Pub. No.: US 2025/0167708 A1
(43) Pub. Date: May 22, 2025

(54) METHOD FOR FLYING-STARTING SENSORLESS VECTOR-CONTROLLED PERMANENT MAGNET SYNCHRONOUS MOTOR

(71) Applicant: Zhongshan Broad-Ocean Motor Co., Ltd., Zhongshan (CN)

(72) Inventor: Wenqing BIAN, Zhongshan (CN)

(21) Appl. No.: 19/023,206

(22) Filed: Jan. 15, 2025

Related U.S. Application Data
(63) Continuation-in-part of application No. PCT/CN2024/081046, filed on Mar. 11, 2024.

(30) Foreign Application Priority Data
Aug. 10, 2023 (CN) 202311000331.0

(51) Int. Cl. H02P 21/34; H02P 21/18; H02P 21/22

(52) U.S. Cl. CPC H02P 21/34; H02P 21/18; H02P 21/22; H02P 2205/01; H02P 2205/07; H02P 2207/05

(57) ABSTRACT

A method for flying-starting a sensorless vector-controlled permanent magnet synchronous motor (PMSM), including: setting, by a speed tracker of a sensorless vector-controlled PMSM in a flying-start state, an actual operating speed of the PMSM as a reference speed command, for field-oriented control to reduce a real-time running current of the PMSM; and checking, using an acceleration adaptive controller, whether the sensorless vector-controlled PMSM is starting with or against wind; if the sensorless vector-controlled PMSM is starting against the wind, setting an acceleration of the PMSM to a preset value; if the sensorless vector-controlled PMSM is starting with the wind, calculating a voltage error defined as a difference between a maximum bus voltage and a real-time bus voltage; and processing, through a proportional-integral controller, the voltage error to output a new acceleration of the PMSM.

### CROSS-REFERENCE TO RELATED APPLICATIONS

This application is a continuation-in-part of International Patent Application No. PCT/CN2024/081046 with an international filing date of Mar. 11, 2024, designating the United States, now pending, further claims foreign priority benefits to Chinese Patent Application No. 202311000331.0 filed Aug. 10, 2023. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to a method for flying-starting a sensorless vector-controlled permanent magnet synchronous motor.

Permanent magnet synchronous motors (PMSM) using vector control are well-regarded for their ability to optimize efficiency and maintain quiet operation, making them suitable for various application, including fans and water pumps.

However, the implementation of sensorless vector control during motor startup presents challenges. The issue arises because the sensorless algorithm relying on motor models is difficult to accurately identify the motor's speed and position at low speeds or when the motor is at rest. To solve the issue, a common practice during motor startup is to employ an open-loop current strategy that forcibly drives the rotor to accelerate according to a predetermined profile until it reaches a specific speed. Once the specific speed is attained, the motor transitions to closed-loop Field Oriented Control (FOC) for precise torque and speed regulation.

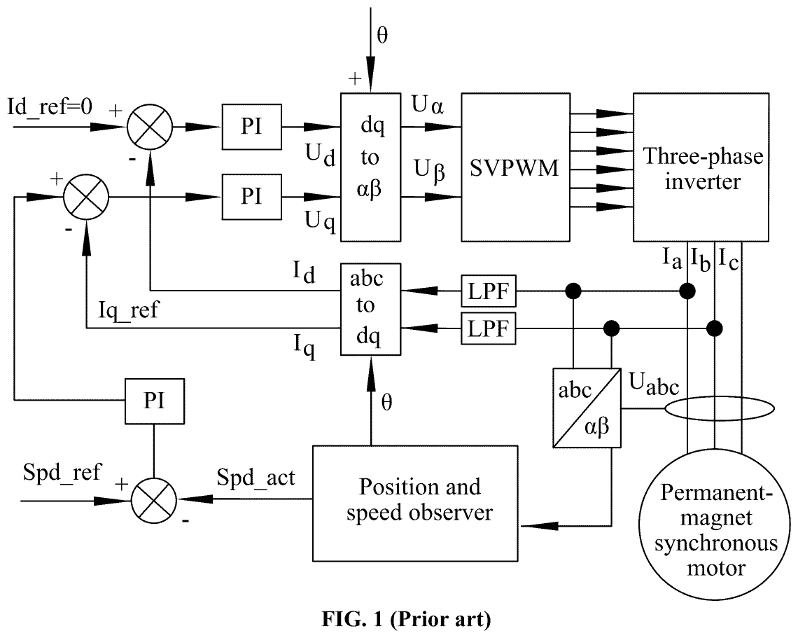

FIG. 1 is a flowchart for the Field-Oriented Control (FOC) of a sensorless vector-controlled PMSM. A reference speed command (Spd_ref) is compared with an actual operating speed (Spd_act) of the sensorless vector-controlled PMSM; the comparison is processed using a first Proportional-Integral (PI) controller; and the first PI controller generates a q-axis reference current (Iq_ref), forming a speed control loop. The q-axis reference current (Iq_ref) is compared with a real-time q-axis current (Iq); the comparison is processed using a second PI controller; and the second PI controller generates a q-axis voltage input vector (Uq), forming a first current control loop. A d-axis reference current (Id_ref) is set to zero and compared with a real-time d-axis current (Id); the comparison is processed using a third PI controller processes; and the third PI controller generates a d-axis voltage input vector (Ud), forming a second current control loop. The q-axis voltage input vector (Uq) and the d-axis voltage input vector (Ud) voltage vectors undergo a coordinate transformation to prepare them for Space Vector Pulse Width Modulation (SVPWM) control. The output of the SVPWM is then fed into a three-phase inverter, and the three-phase inverter generates the phase currents (Ia, Ib, Ic) for a motor winding. The phase currents (Ia, Ib, Ic) are transformed back into a q-axis current component (Iq) and a d-axis current component (Id) using coordinate transformation. The phase currents (Ia, Ib, Ic) and a DC bus voltage are input into a position and speed observer. The position and speed observer outputs an actual operating speed (Spd_act) and a transformation angle (θ).

Sensorless vector control of PMSMs often encounter the problem of flying start in practical use. The flying start in the wind turbine is usually called downwind start, that is, the motor rotates forward or reversely at a certain speed. For example, air conditioning outdoor units are usually used in permanent magnet synchronous motors as heat exchange of the outdoor fan. The motor often stops and starts according to the logical instructions of the air conditioning system during use. When restarting, the rotor of the motor may be rotating in reverse or forward direction due to external airflow pressure or fan inertia. When starting the motor, there is no position sensor and it is not known whether the motor is rotating. If open-loop forced start is directly used, because the speed and position cannot be recognized, it will inevitably cause the motor to be in a generator running state, which will cause the DC bus voltage to pump up, either trigger overvoltage protection, or cause overvoltage damage to power devices. Therefore, special treatment is needed for the motor's flying start.

A conventional solution for starting motors in outdoor units includes applying zero voltage to the motor prior to startup, specifically, using a three-phase bridge circuit with a PWM duty cycle of 50% for the upper and lower switches. This initial step allows for the measurement of phase currents, which helps to determine the motor's initial speed and rotation direction. However, the solution faces two key challenges. First, applying a zero-voltage vector when the rotor speed is high can lead to excessive and uncontrollable phase currents. Second, the need to switch between different handling modes based on various speed levels complicates the control process, making it more difficult to implement effectively.

### SUMMARY

To solve the aforesaid problems, the disclosure provides a method for flying-starting a sensorless vector-controlled permanent magnet synchronous motor (PMSM), and the method comprises:
speed tracking: setting, by a speed tracker of a sensorless vector-controlled PMSM in a flying-start state, an actual operating speed (Spd_act) of the PMSM as a reference speed command (Spd_ref); with a q-axis reference current (Iq_ref) and a d-axis reference current (Id_ref) at zero, for Field-Oriented Control (FOC) algorithm to reduce a real-time running current of the PMSM;
acceleration adaptive control: checking, using an acceleration adaptive controller, whether the sensorless vector-controlled PMSM is starting with or against wind; if the sensorless vector-controlled PMSM is starting against the wind, setting an acceleration of the PMSM to a preset value (a0); if the sensorless vector-controlled PMSM is starting with the wind, calculating a voltage error defined as a difference between a maximum bus voltage and a real-time bus voltage; and processing, through a Proportional-Integral (PI) controller, the voltage error to output a new acceleration (a) of the PMSM;
where, Spd_ref is the reference speed command used in a speed control loop.

In a class of this embodiment, the method enhances the startup control of the sensorless vector-controlled PMSM in the flying-start state by incorporating the speed tracking and the acceleration adaptive control into the FOC strategy. The speed tracking and the acceleration adaptive control work as follows:
speed tracking: During startup in the flying-start state, the speed tracker is initiated to monitor the actual operating speed (Spd_act); the actual operating speed (Spd_act) is set as the reference speed command (Spd_ref); both the q-axis reference current (Iq_ref) and the d-axis reference current (Id_ref) are set to zero; the FOC strategy is applied; when a real-time q-axis current (Iq) drops below a preset q-axis current (Iq0), the speed tracker is disengaged, and the reference speed command (Spd_ref) is recorded; a first PI controller compares the q-axis reference current (Iq_ref) with the real-time q-axis current (Iq) to form a first current control loop; a second PI controller compares the d-axis reference current (Id_ref) with a real-time d-axis current (Id) to form a second current control loop;
acceleration adaptive control: after the speed tracking is completed, the recorded reference speed command (Spd_ref) is compared with a target startup speed (Spd_target); if the recorded reference speed command (Spd_ref) is less than the target startup speed (Spd_target), the acceleration is set to a preset value (a0); if the recorded reference speed command (Spd_ref) is greater than the target startup speed (Spd_target), the voltage error is calculated as the difference between the maximum bus voltage and the real-time bus voltage; and the voltage error is processed through a third PI controller to generate the new acceleration (a);
after the acceleration adaptive control is completed, FOC strategy is applied to adjust the actual operating speed (Spd_act) to approach the target startup speed (Spd_target).

In a class of this embodiment, upon performing the FOC strategy, the PMSM starts with the recorded reference speed command (Spd_ref) and increases the reference speed command (Spd_ref), step by step, using the new acceleration (a) as the step size, to bring the reference speed command (Spd_ref) to match the target speed (Spd_target).

In a class of this embodiment, when the reference speed command (Spd_ref) exceeds the target speed (Spd_target), the new acceleration (a) is calculated as follows:

$$a = kp \times error + \int ( ki \times error ) dt$$

where, kp and ki are the parameters of the PI controller.

In a class of this embodiment, specifically, the method comprises:
S1: initializing all parameters, and setting a flag (Flag) to 1 for the speed tracker;
S2: reading bus voltage (Vbus), phase currents, and the target startup speed (Spd_target); calculating the actual operating speed (Spd_act), the real-time q-axis current (Iq), and the real-time d-axis current (Id);
S3: checking if the flag (Flag) is 1; if yes, proceeding to S4; if no, skipping to S6;
S4: Speed tracking: setting the actual operating speed (Spd_act) as the reference speed command (Spd_ref); checking if the real-time q-axis (Iq) is less than the preset q-axis current (Iq0); if no, moving to S5; if yes, setting the flag (Flag) to zero, recording the reference speed command (Spd_ref), and proceeding to S6;
S5: setting both the q-axis reference current (Iq_ref) and the d-axis reference current (Id_ref) to zero; applying the FOC strategy, and returning to S2;
S6: Acceleration adaptive control: checking if the reference speed command (Spd_ref) is greater than the target startup speed (Spd_target); if no, setting the acceleration to a preset value (a0); if yes, calculating the voltage error defined as the difference between the maximum bus voltage and the real-time bus voltage; processing, through the PI controller, the voltage error to output the new acceleration (a); and then proceeding to S7;
S7: recalculating, using the new acceleration (a), the reference speed command (Spd_ref); comparing, through the PI controller, the recalculated reference speed command (Spd_ref) with the actual operating speed (Spd_act); performing FOC strategy, and then returning to S2.

In a class of this embodiment, during the execution of the FOC strategy, the d-axis reference current (Id_ref) is generated by an MTPA unit.

The following advantages are associated with the disclosure:

The disclosed method uses a speed tracker that automatically monitors the motor's speed during startup and controls the acceleration of the sensorless vector-controlled PMSM. The speed tracker prevents the sensorless vector-controlled PMSM from spinning in reverse and generating power, thereby reducing the risk of over-voltage in a motor controller. Therefore, an inverter is protected from over-voltage damage that could harm power components, greatly improving reliability.

The disclosed method incorporates a simple and efficient logical algorithm to improve motor startup. Specifically, the logical algorithm controls both the motor's current and speed during startup, ensuring the motor's current remains within a safe range. Meanwhile, the motor smoothly transitions from the actual operating speed to the target speed, leading to a quieter operation.

### DETAILED DESCRIPTION OF THE DRAWINGS

FIG. 1 is a flowchart of the working principle of Field-Oriented Control (FOC) for a conventional sensorless vector-controlled permanent magnet synchronous motor;

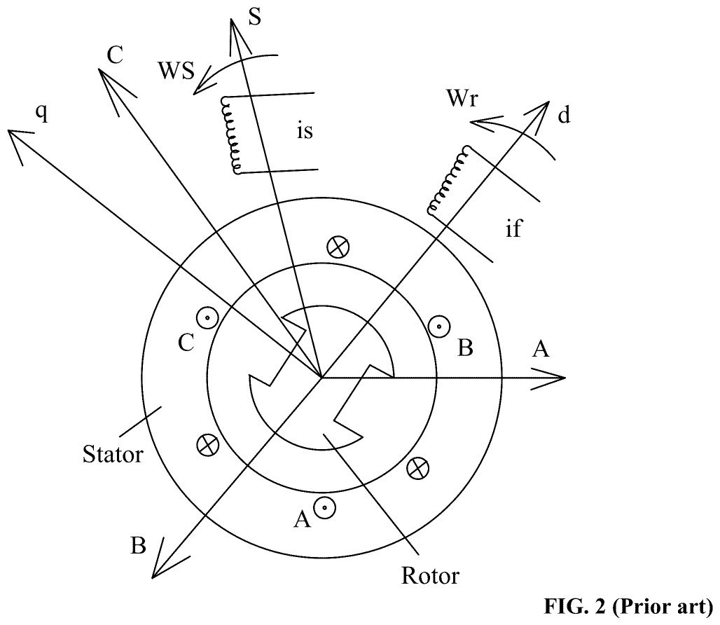

FIG. 2 is a schematic diagram of the working principle of a conventional sensorless vector-controlled permanent magnet synchronous motor;

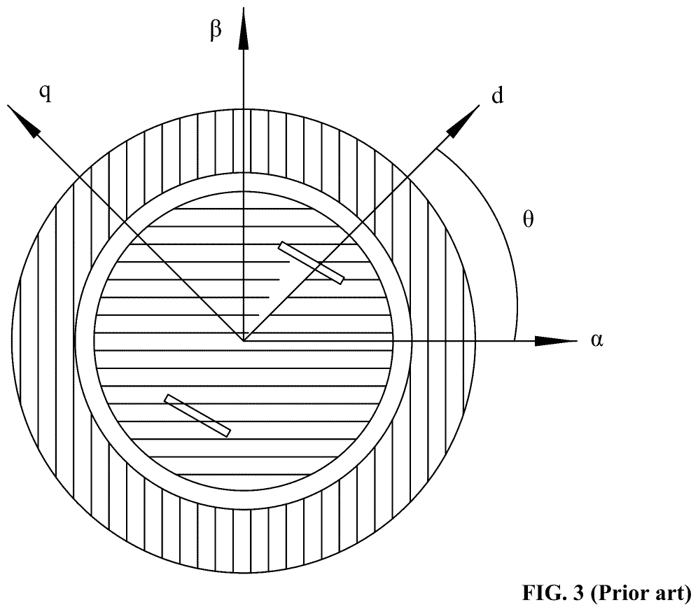

FIG. 3 shows the relationship between different coordinate systems used in vector control for a conventional sensorless vector-controlled permanent magnet synchronous motor;

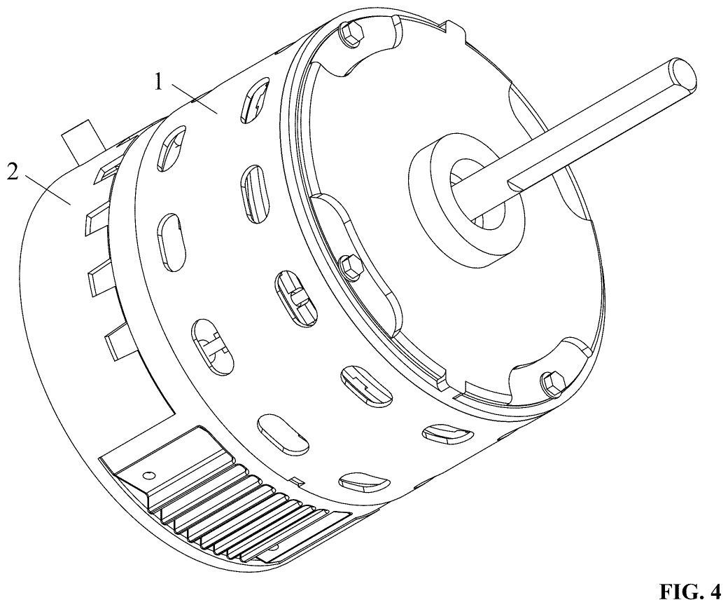

FIG. 4 is a perspective view of a sensorless vector-controlled permanent magnet synchronous motor according to one embodiment of the disclosure;

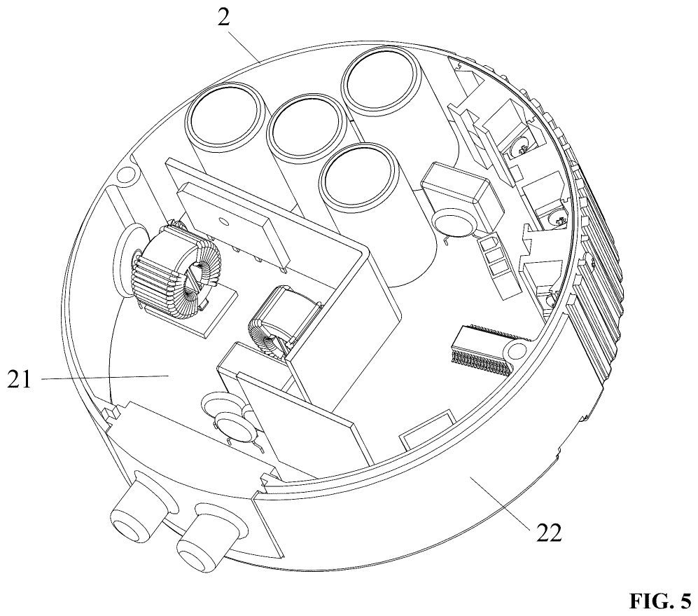

FIG. 5 is a perspective view of a motor controller according to one embodiment of the disclosure;

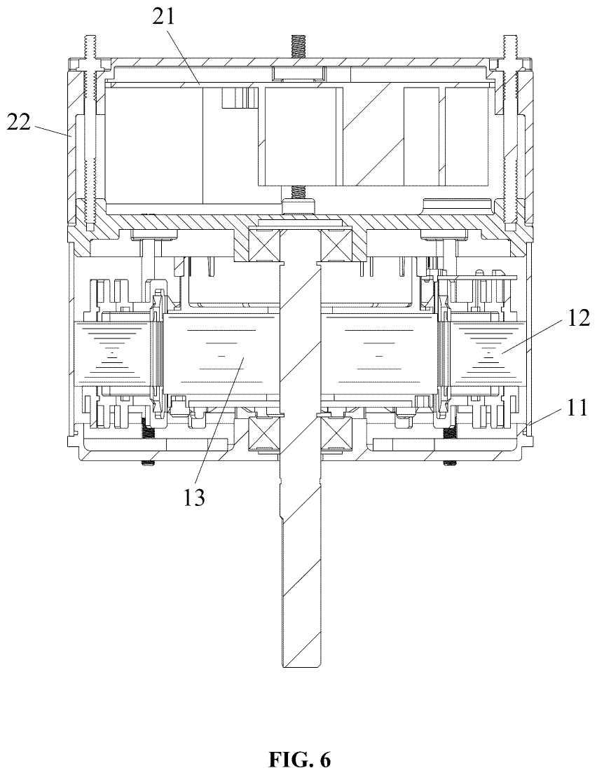

FIG. 6 is a cross-sectional view of a sensorless vector-controlled permanent magnet synchronous motor according to one embodiment of the disclosure;

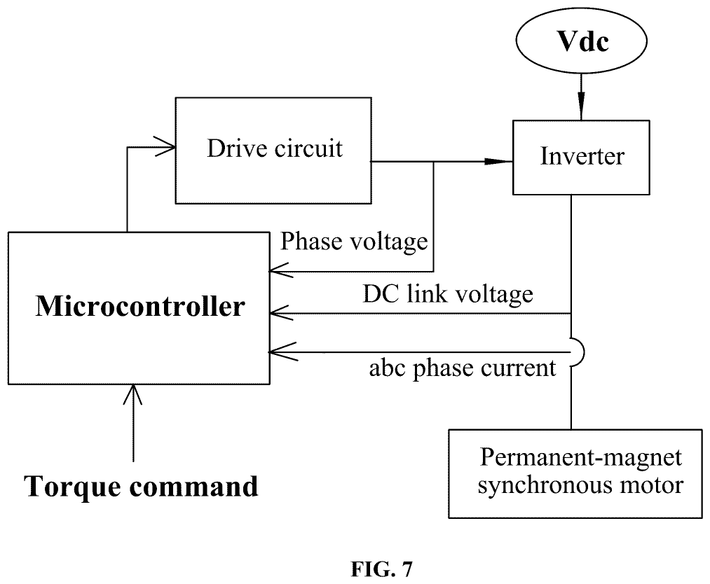

FIG. 7 is a block diagram of the working principle of a motor controller according to one embodiment of the disclosure;

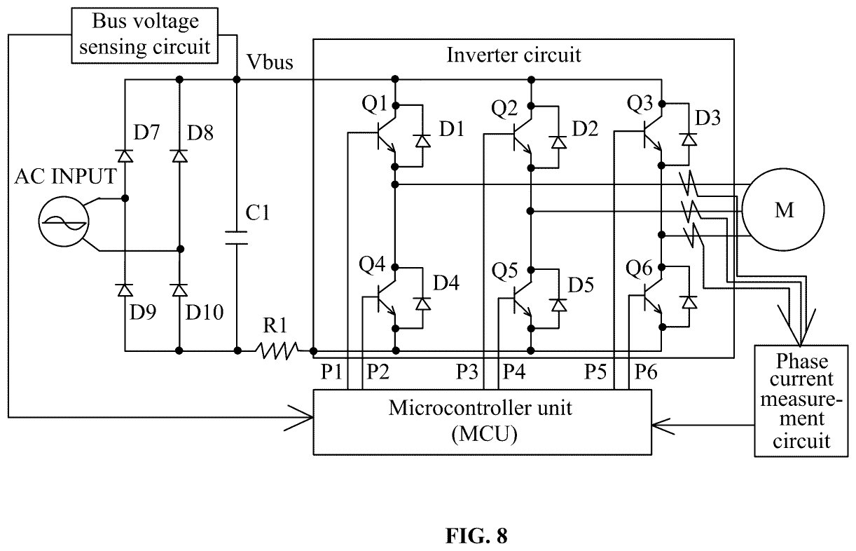

FIG. 8 is a circuit diagram of FIG. 7;

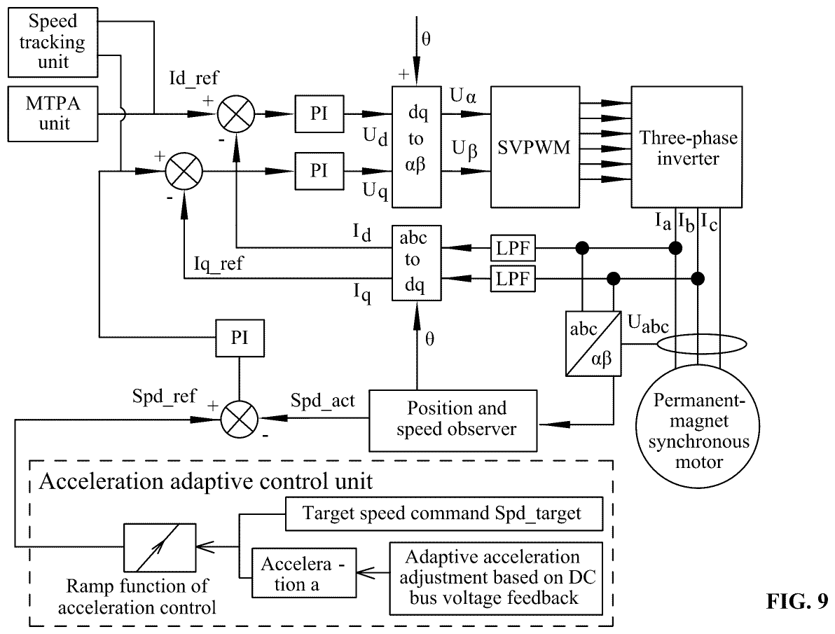

FIG. 9 is a flowchart of a vector control process used in a sensorless vector-controlled permanent magnet synchronous motor according to one embodiment of the disclosure;

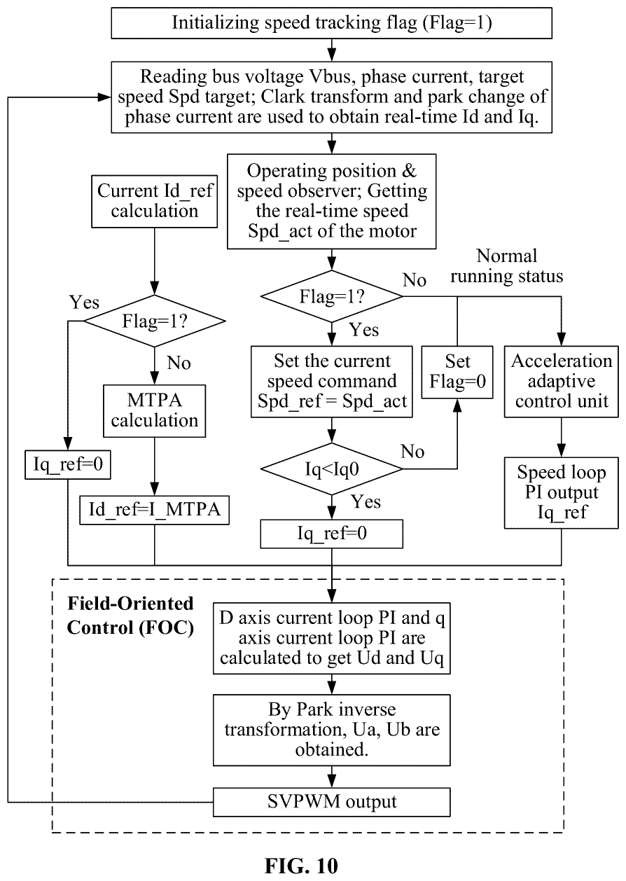

FIG. 10 is a program control flowchart for a sensorless vector-controlled permanent magnet synchronous motor according to one embodiment of the disclosure;

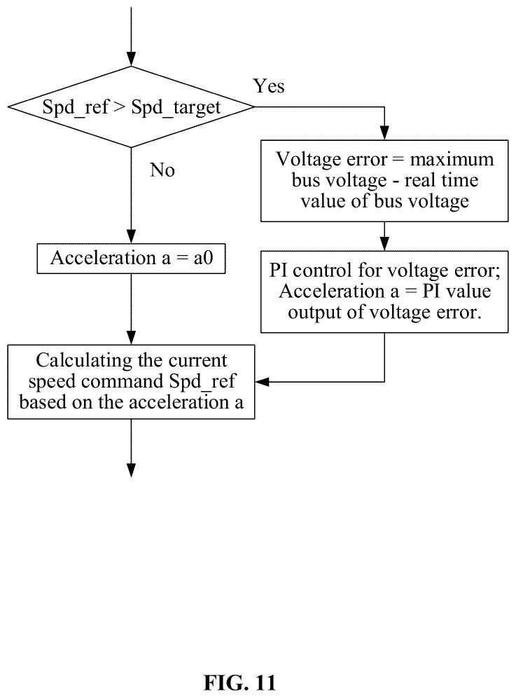

FIG. 11 is a program control flowchart for an adaptive acceleration controller in FIG. 10;

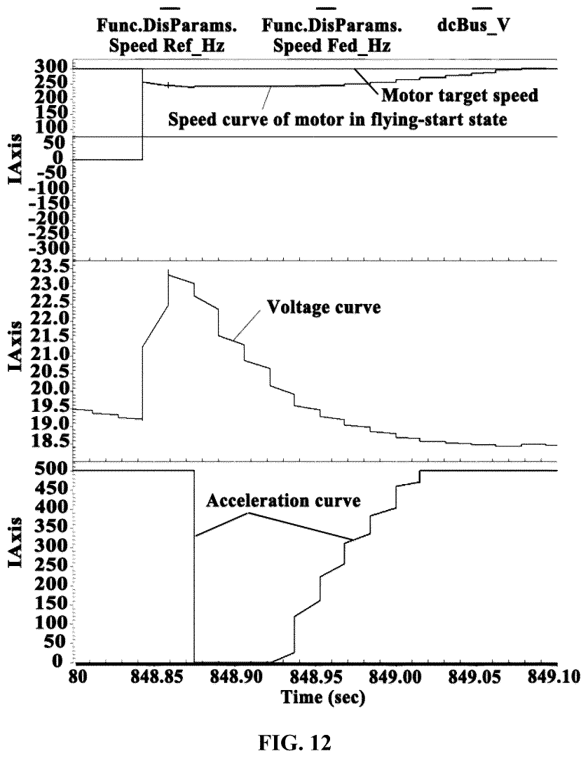

FIG. 12 is a diagram showing the variation in speed, voltage, and acceleration during downwind startup for a sensorless vector-controlled permanent magnet synchronous motor according to one embodiment of the disclosure;

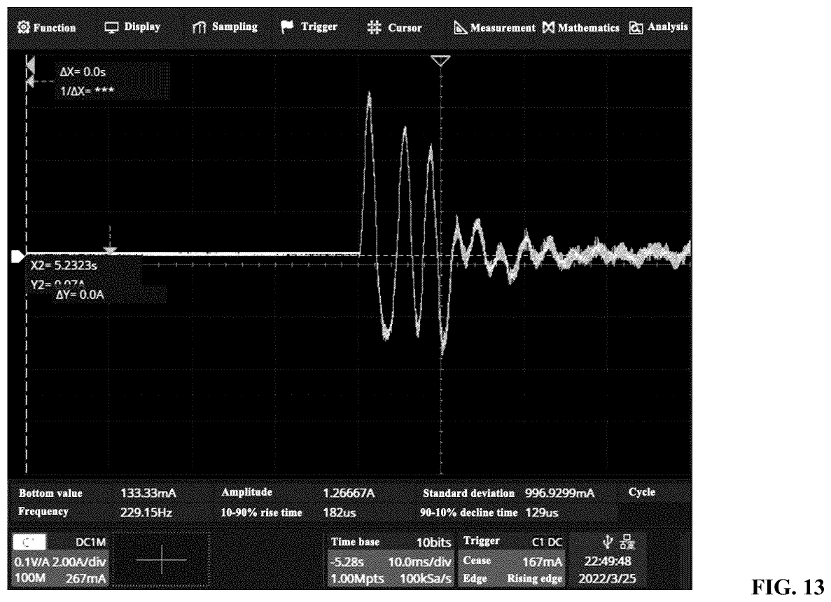

FIG. 13 is a diagram showing the current variation during downwind startup according to one embodiment of the disclosure;

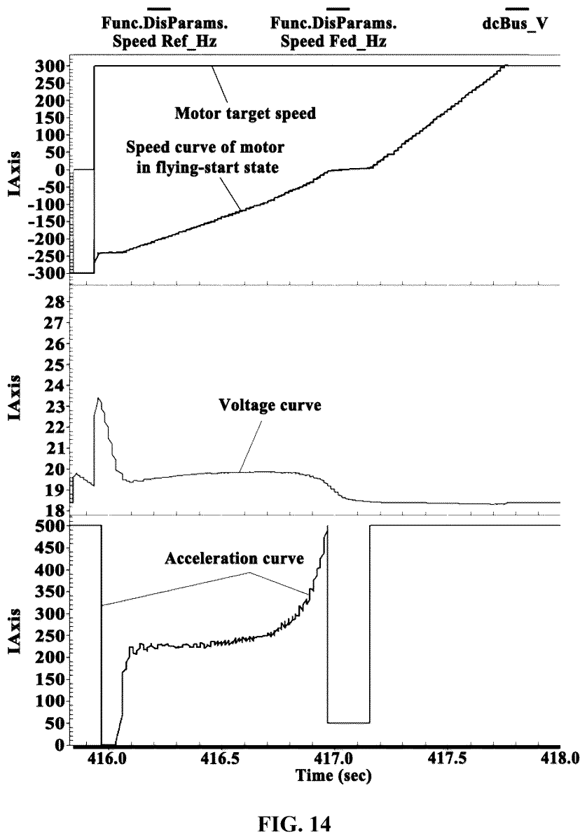

FIG. 14 is a diagram showing the changes in speed, voltage, and acceleration during upwind startup according to one embodiment of the disclosure; and

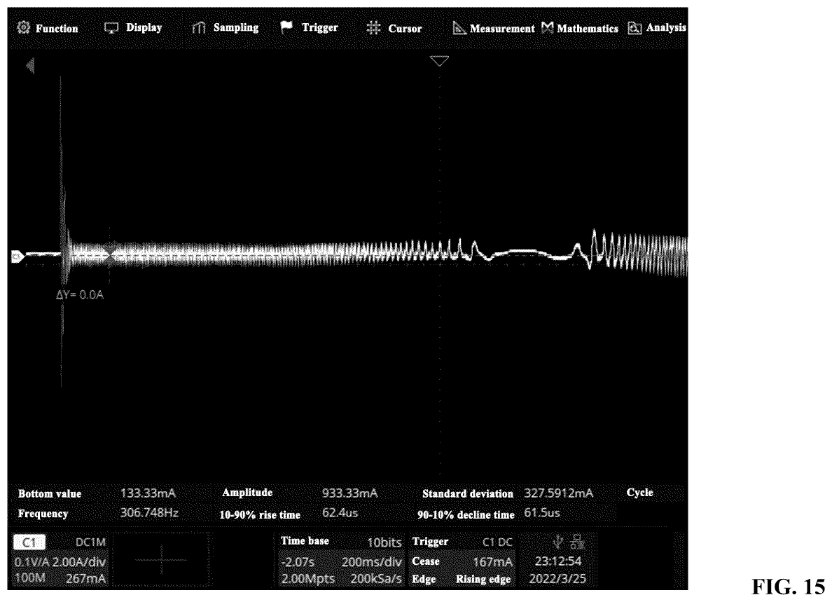

FIG. 15 is a diagram showing the current variation during upwind startup according to one embodiment of the disclosure.

### DETAILED DESCRIPTION

To further illustrate the disclosure, embodiments detailing a method for flying-starting a sensorless vector-controlled permanent magnet synchronous motor. It should be noted that the following embodiments are intended to describe and not to limit the disclosure.

As shown in FIG. 2, a basic working principle of a sensorless vector-controlled PMSM can be understood through the interaction of the stator's rotating magnetic field and the rotor's magnetic field. Referring to FIG. 2, the operation of the sensorless vector-controlled PMSM is based on two coordinate systems: a rotor's rotating dq reference frame and a stator's stationary ABC reference frame. The stationary ABC reference frame can be transformed into an orthogonal αβ coordinate system. The rotor is driven by the rotor excitation current (if) and rotates at a speed (wr). The stator, energized by the stator excitation current (is), generates a rotating magnetic field that rotates at a speed (ws). The rotating magnetic field can be represented as a resultant vector S. The electromagnetic torque (Te) generated by the sensorless vector-controlled PMSM can be expressed as follows:

$${T}_{e} = {P}_{0} \cdot {ψ}_{f} \times {i}_{q} \qquad ( 1 )$$

where, P0 represents the number of pole pairs in the motor, which is a constant; Ψf is the magnetic flux linkage generated by the rotor excitation current (if). Since the rotor is a permanent magnet, when if=0, Ψf remains constant, the electromagnetic torque (Te) is expressed as follows:

$${T}_{e} = K \times {i}_{q} \qquad ( 2 )$$

where, K is a constant, and the electromagnetic torque (Te) is directly related to the q-axis current.

As shown in FIG. 3, the stationary ABC reference frame is replaced with an orthogonal αβ coordinate system. The orthogonal αβ coordinates are aligned with the stationary stator, while the rotating dq reference frame represent the rotating rotor. The angle between the orthogonal αβ coordinate system and the rotating dq reference frame is denoted as θ.

As shown in FIGS. 4-6, a sensorless vector-controlled three-phase PMSM comprises a motor controller 2 and a motor unit 1 (denoted as M in FIG. 8). The motor unit 1 comprises a stator assembly 12, a rotor assembly 13, and a housing assembly 11. The stator assembly 12 is disposed on the housing assembly 11. The rotor assembly 13 is disposed inside or outside the stator assembly 12. The motor controller 2 comprises a control box 22 and an electronic control board 21. The electronic control board 21 is disposed inside the control box 22. The electronic control board 21 typically comprises a power circuit, a microprocessor, a bus voltage detection circuit, and an inverter. The power circuit is configured to supply energy to all components. The bus voltage detection circuit is configured to input the DC bus voltage (Vbus) into the microprocessor. The microprocessor is configured to control the inverter to manage the on/off operation of the stator windings. The microprocessor is a microcontroller unit (MCU).

As shown in FIGS. 7 and 8, in a three-phase brushless DC permanent magnet synchronous motor (BLDC PMSM), the current detection circuit measures the current in each of motor's three phases: Ia, Ib, and Ic. The phase currents Ia, Ib, and Ic are set to the microprocessor. A full-wave rectifier comprises diodes D7, D8, D9, and D10. The AC input voltage is converted to the DC bus voltage (Vbus) through the full-wave rectifier and smoothed by a capacitor (C1). The DC bus voltage fluctuates depending on the AC input voltage. The microprocessor generates six PWM signals (P1, P2, P3, P4, P5, and P6) with specific duty cycles. The inverter comprises six electronic switches (Q1, Q2, Q3, Q4, Q5, and Q6). The microprocessor sends the six PWM signals (P1, P2, P3, P4, P5, and P6) to control the six electronic switches (Q1, Q2, Q3, Q4, Q5, and Q6). The duty cycle determines how long each switch remains in the “on” state.

As shown in FIGS. 3 and 9, the phase currents (Ia, Ib, Ic) are used to calculate the real-time d-axis current (Id) and real-time q-axis current (Iq). A position and speed observer is used to estimate the angle θ between the orthogonal αβ coordinate system and the rotating dq reference frame, as well as the actual operating speed (Spd_act). Optionally, a flux observer is disposed inside the microprocessor to calculate the magnetic flux (φ). The magnetic flux (φ) is calculated using the parameters Id, Iq, θ, motor resistance, inductance, and the actual operating speed. The calculations are common knowledge and are typically found in textbooks. Therefore, detailed explanations of the calculations are not provided herein.

As shown in FIG. 9, a method for flying-starting a sensorless vector-controlled PMSM, and the method comprises:

Speed tracking: setting, by a speed tracker of a sensorless vector-controlled PMSM in a flying-start state, an actual operating speed (Spd_act) as a reference speed command (Spd_ref), with a q-axis reference current (Iq_ref) and a d-axis reference current (Id_ref) at zero, for Field-Oriented Control (FOC) algorithm to reduce a real-time running current of the PMSM;

Acceleration adaptive control: checking, using the acceleration adaptive controller, whether the sensorless vector-controlled PMSM is starting with or against the wind; if the sensorless vector-controlled PMSM is starting against the wind, setting the acceleration of the PMSM to the present value (a0); if the sensorless vector-controlled PMSM is starting with the wind, calculating the voltage error defined as the difference between the maximum bus voltage and the real-time bus voltage; and processing, through the PI controller, the voltage error to output a new acceleration (a) of the PMSM;
wherein, Spd_ref is the reference speed command used in a speed control loop.

The method enhances the startup control of the sensorless vector-controlled PMSM in the flying-start state by incorporating the speed tracking and the acceleration adaptive control into the FOC strategy. The speed tracking and the acceleration adaptive control work as follows:
Speed tracking: During startup in the flying-start state, the speed tracker is initiated to monitor the actual operating speed (Spd_act); the actual operating speed (Spd_act) is set as the reference speed command (Spd_ref); both the q-axis reference current (Iq_ref) and the d-axis reference current (Id_ref) are set to zero; the FOC strategy is applied; when the real-time q-axis current (Iq) drops below a preset q-axis current (Iq0), the speed tracker is disengaged, and the reference speed command (Spd_ref) is recorded; a first PI controller compares the q-axis reference current (Iq_ref) with the real-time q-axis current (Iq) to form a first current control loop; a second PI controller compares the d-axis reference current (Id_ref) with the real-time d-axis current (Id) to form a second current control loop;
Acceleration adaptive control: after the speed tracking is completed, the recorded reference speed command (Spd_ref) is compared with a target startup speed (Spd_target); if the recorded reference speed command (Spd_ref) is less than the target startup speed (Spd_target), the acceleration is set to a preset value (a0); if the recorded reference speed command (Spd_ref) is greater than the target startup speed (Spd_target), the voltage error is calculated as the difference between the maximum bus voltage and the real-time bus voltage; and the voltage error is processed through a third PI controller to generate the new acceleration (a);
After the acceleration adaptive control is completed, FOC strategy is applied to adjust the actual operating speed (Spd_act) to approach the target startup speed; specifically, the PMSM starts with the recorded reference speed command (Spd_ref) and gradually increases the reference speed command (Spd_ref), step by step, using the new acceleration (a) as the step size, so that the actual operating speed matches the target startup speed (Spd_target).

The disclosure enhances the field-oriented control (FOC) algorithm by incorporating the speed tracker, the acceleration adaptive controller, and the MTPA (Maximum Torque per Ampere) unit specifically for starting the motor in the flying-start state The term “flying-start state”, as used herein, refers to the state where the motor is already rotating at a certain speed prior to receiving a startup command. The rotation could occur in either the forward or reverse direction, commonly due to external factors such as wind. When the startup command is issued while the sensorless vector-controlled PMSM is in the flying-start state, the speed tracker is initiated to monitor the actual operating speed (Spd_act); the actual operating speed (Spd_act) is set as the reference speed command (Spd_ref); both the q-axis reference current (Iq_ref) and the d-axis reference current (Id_ref) are set to zero; the FOC strategy is applied; when the real-time q-axis current (Iq) drops below a preset q-axis current (Iq0), the speed tracker is disengaged, and the reference speed command (Spd_ref) is recorded; the first PI controller compares the q-axis reference current (Iq_ref) with the real-time q-axis current (Iq) to form a first current control loop; the second PI controller compares the d-axis reference current (Id_ref) with the real-time d-axis current (Id) to form a second current control loop; the preset q-axis current (Iq0) is set as a safety limit, ensuring that both the real-time d-axis current and the real-time q-axis current remain within safe levels, particularly during sudden changes in speed.

When the reference speed command (Spd_ref) exceeds the target speed (Spd_target), the new acceleration (a) is calculated as follows:

$$a = kp \times error + \int ( ki \times error ) dt$$

where, Kp and Ki are the parameters of the PI controller.

As shown in FIGS. 10 and 11, specifically, the method comprises:
S1: initializing all parameters, and setting a flag (Flag) to 1 for the speed tracker;
S2: reading the bus voltage (Vbus), the phase currents, and the target startup speed (Spd_target); calculating the actual operating speed (Spd_act), the real-time q-axis current (Iq), and the real-time d-axis current (Id);
S3: checking if the flag (Flag) is 1; if yes, proceeding to S4; if no, skipping to S6;
S4: Speed tracking: setting the actual operating speed (Spd_act) as the reference speed command (Spd_ref); checking if the real-time q-axis (Iq) is less than the preset q-axis current (Iq0); if no, moving to S5; if yes, setting the flag (Flag) to zero, recording the reference speed command (Spd_ref), and proceeding to S6;
S5: setting both the q-axis reference current (Iq_ref) and the d-axis reference current (Id_ref) to zero; applying the FOC strategy, and returning to S2;
S6: Acceleration adaptive control: checking if the reference speed command (Spd_ref) is greater than the target startup speed (Spd_target); if no, setting the acceleration to a preset value (a0); if yes, calculating the voltage error defined as the difference between the maximum bus voltage and the real-time bus voltage; processing, through the PI controller, the voltage error to output the new acceleration (a); and then proceeding to S7;
S7: recalculating, using the new acceleration (a), the reference speed command (Spd_ref); comparing, through the PI controller, the recalculated reference speed command (Spd_ref) with the actual operating speed (Spd_act); performing FOC strategy, and then returning to S2.

During the execution of the FOC strategy, the d-axis reference current (Id_ref) is generated by the MTPA unit. The MTPA unit is configured to calculate the optimal d-axis reference current (Id_ref), especially to maximize torque produced by the motor for each ampere of current supplied. The concept is well-documented in motor control literature and patents, so detailed calculations are not provided herein. When the motor exits the speed tracker, the q-axis reference current (Iq_ref) is determined by the difference between the reference speed command (Spd_ref) and the actual operating speed (Spd_act). The speed difference is represented as err_spd=Spd_ref−Spd_act; and the q-axis reference current (Iq_ref) is calculated by processing the speed error through the PI controller in the speed control loop.

$$Iq\_ref = kp \times err\_spd + \int ( ki \times err\_spd ) dt$$

where, Kp and Ki are the parameters of the PI controller.

By using the q-axis reference current Iq_ref output from the PI controller in the speed control loop and the d-axis reference current Id_ref generated by the MTPA unit, the FOC strategy is performed to achieve maximum torque per ampere.

As shown in FIGS. 12 and 13, a test was conducted to evaluate the effectiveness of the method for starting the sensorless vector-controlled PMSM under high-speed conditions (300 Hz startup), where the sensorless vector-controlled PMSM was already rotating in the same direction as the startup command. The momentary voltage spikes may occur during the startup process. The testing method was performed as follows:
1. The speed tracker was activated to monitor the actual operating speed (Spd_act); the actual operating speed (Spd_act) was set as the reference speed command (Spd_ref); both the q-axis reference current (Iq_ref) and the d-axis reference current (Id_ref) was set to zero; the real-time q-axis current (Iq) was continuously monitored; when the real-time q-axis current (Iq) dropped to an acceptable level, the speed tracker was disengaged, allowing the motor to transition into a normal speed mode; in the normal speed mode, the acceleration adaptive controller was activated;
2. During the speed tracking phase, as the voltage increases, the actual operating speed decreased; the decrease in speed subsequently lowered the reference speed command (Spd_ref);
3. During the speed tracking phase, the acceleration calculated by the PI controller is set to zero; when the motor transitions to the normal speed mode, the PI controller adjusted the acceleration based on the voltage error;
4. As the acceleration gradually increased, the reference speed command (Spd_ref) was brought up to match the target startup speed (Spd_target).

FIG. 12 illustrates the test results for the high-speed tailwind startup at 300 Hz for the sensorless vector-controlled PMSM. The top graph shows comparison between the target startup speed (Spd_target) and the actual operating speed (Spd_act) during the startup process. The middle graph represents the behavior of the bus voltage during the startup process. The bottom graph shows the changes in acceleration during the startup process. Notably, significant voltage fluctuations only occurred during the speed tracking phase, which can be absorbed by the capacitor. When the speed tracking was completed, the motor smoothly accelerated to the target startup speed (Spd_target). FIG. 13 indicates that during the startup of the motor in a flying-start state, the maximum current fluctuation remained below 1.267 A, satisfying the design requirements.

As shown in FIGS. 14 and 15, another test was conducted to evaluate the effectiveness of the disclosed method for starting the sensorless vector-controlled PMSM under high-speed conditions (300 Hz startup), where the sensorless vector-controlled PMSM was already rotating in reverse as the startup command. The momentary voltage spikes may occur during the startup process. The testing method was performed as follows:
1. The speed tracker was activated to monitor the actual operating speed (Spd_act); the actual operating speed (Spd_act) was set as the reference speed command (Spd_ref); both the q-axis reference current (Iq_ref) and the d-axis reference current (Id_ref) were set to zero; the real-time q-axis current (Iq) was continuously monitored; when the real-time q-axis current (Iq) dropped to an acceptable level, the speed tracker disengaged; the actual operating speed (Spd_act) gradually decreases, acting like a brake, which caused a slight rise in voltage; and
2. At the moment of startup, voltage spikes were observed; when the speed tracker was successfully engaged, the acceleration dropped to zero, and the real-time q-axis current (Iq) began to decrease. Once the real-time q-axis current (Iq) dropped below the preset q-axis current (Iq0), the deceleration increased, and the motor switched into a positive torque control mode; when the actual operating speed (Spd_act) approached zero, the acceleration was minimized; after achieving positive torque, the motor entered normal operation mode; the motor accelerated from the preset value (a0) until the reference speed command (Spd_ref) was brought up to match the target startup speed (Spd_target).

As shown in FIG. 14, significant voltage fluctuations occurred only during the speed tracking phase and can be absorbed by capacitors. When the speed tracking was completed, the motor started decelerating from an initial speed of −300 Hz. During the deceleration, the bus voltage was kept around 20 V, and the acceleration decreased from 500 Hz per second to about 200 Hz per second. After the bus voltage dropped, the acceleration smoothly transitioned to the present value (a0). When the motor slowed down to near zero speed, the control system followed the new acceleration to bring the motor up to 300 Hz. As shown in FIG. 15, during the startup of the motor in the flying-start state, the maximum current fluctuation remained below 933 mA, satisfying the design requirements.

The disclosed method uses a speed tracker that automatically monitors the motor's speed during startup and controls the acceleration of the sensorless vector-controlled PMSM. The speed tracker prevents the sensorless vector-controlled PMSM from spinning in reverse and generating power, thereby reducing the risk of over-voltage in the motor controller. Therefore, the inverter is protected from over-voltage damage that could harm power components, greatly improving reliability. The disclosed method incorporates a simple and efficient logical algorithm to improve motor startup. Specifically, the logical algorithm controls both the motor's current and speed during startup, ensuring the motor's current remains within a safe range. Meanwhile, the motor smoothly transitions from the current speed to the target speed, leading to a quieter operation.

It will be obvious to those skilled in the art that changes and modifications may be made, and therefore, the aim in the appended claims is to cover all such changes and modifications.

What is claimed is:

1. A method for flying-starting a sensorless vector-controlled permanent magnet synchronous motor (PMSM), the method comprising:
setting, by a speed tracker of a sensorless vector-controlled PMSM in a flying-start state, an actual operating speed (Spd_act) of the PMSM as a reference speed command (Spd_ref), with a q-axis reference current (Iq_ref) and a d-axis reference current (Id_ref) at zero, for field-oriented control (FOC) to reduce a real-time running current of the PMSM, where, the reference speed command (Spd_ref) is a current speed command used in a speed control loop; and
checking, using an acceleration adaptive controller, whether the sensorless vector-controlled PMSM is starting with or against wind; if the sensorless vector-controlled PMSM is starting against the wind, setting an acceleration of the PMSM to a preset value (a0); if the sensorless vector-controlled PMSM is starting with the wind, calculating a voltage error defined as a difference between a maximum bus voltage and a real-time bus voltage; and processing, through a proportional-integral (PI) controller, the voltage error to output a new acceleration (a) of the PMSM.

2. The method of claim 1, wherein the speed tracker and the acceleration adaptive controller are two additional units to a field-oriented control strategy;
during startup in the flying-start state, the speed tracker is initiated to monitor the actual operating speed (Spd_act); the actual operating speed (Spd_act) is set as the reference speed command (Spd_ref); both the q-axis reference current (Iq_ref) and the d-axis reference current (Id_ref) are set to zero; the FOC strategy is applied, until a real-time q-axis current (Iq) drops below a preset q-axis current (Iq0); the speed tracker is disengaged, and the reference speed command (Spd_ref) is recorded; a first PI controller compares the q-axis reference current (Iq_ref) with the real-time q-axis current (Iq) to form a first current control loop; a second PI controller compares the d-axis reference current (Id_ref) with a real-time d-axis current (Id) to form a second current control loop;
after the speed tracking is completed, the recorded reference speed command (Spd_ref) is compared with a target startup speed (Spd_target); if the recorded reference speed command (Spd_ref) is less than the target startup speed (Spd_target), the acceleration is set to a preset value (a0); if the recorded reference speed command (Spd_ref) is greater than the target startup speed (Spd_target), the voltage error is calculated as the difference between the maximum bus voltage and the real-time bus voltage; and the voltage error is processed through a third PI controller to generate the new acceleration (a); and
after acceleration adaptive control is completed, the FOC strategy is applied to adjust the actual operating speed (Spd_act) to approach the target startup speed (Spd_target).

3. The method of claim 2, wherein upon performing the FOC strategy, the PMSM starts with the recorded reference speed command (Spd_ref) and increases the reference speed command (Spd_ref), step by step, using the new acceleration (a) as a step size, to bring the reference speed command (Spd_ref) to match the target speed (Spd_target).

4. The method of claim 3, wherein when the reference speed command (Spd_ref) exceeds the target speed (Spd_target), the new acceleration (a) is calculated as follows:
$$a = kp \times error + \int ( ki \times erorr ) dt$$
where, kp and ki are parameters of the PI controller.

5. The method of claim 4, comprising:
S1: initializing all parameters, and setting a flag (Flag) to 1 for the speed tracker;
S2: reading bus voltage (Vbus), phase currents, and the target startup speed (Spd_target); calculating the actual operating speed (Spd_act), the real-time q-axis current (Iq), and the real-time d-axis current (Id);
S3: checking if the flag (Flag) is 1; if yes, proceeding to S4; if no, skipping to S6;
S4: speed tracking: setting the actual operating speed (Spd_act) as the reference speed command (Spd_ref); checking if the real-time q-axis (Iq) is less than the preset q-axis current (Iq0); if no, moving to S5; if yes, setting the flag (Flag) to zero, recording the reference speed command (Spd_ref), and proceeding to S6;
S5: setting both the q-axis reference current (Iq_ref) and the d-axis reference current (Id_ref) to zero; applying the FOC strategy, and returning to S2;
S6: checking if the reference speed command (Spd_ref) is greater than the target startup speed (Spd_target); if no, setting the acceleration to a preset value a0; if yes, calculating the voltage error defined as the difference between the maximum bus voltage and the real-time bus voltage; processing, through the PI controller, the voltage error to output the new acceleration a; and then proceeding to S7;
S7: recalculating, using the new acceleration a, the reference speed command (Spd_ref); comparing, through the PI controller, the recalculated reference speed command (Spd_ref) with the actual operating speed (Spd_act); performing FOC strategy, and then returning to S2.

6. The method of claim 5, wherein during the execution of the FOC strategy, the d-axis reference current (Id_ref) is generated by a maximum torque per ampere (MTPA) unit.
